(19) United States
(12) Patent Application Publication
(10) Pub. No.: US 2020/0136492 A1
(43) Pub. Date: Apr. 30, 2020

(54) IMPROVED MAGNETIC CLUTCH ASSEMBLY

(71) Applicant: INTELLITECH PTY LTD, Malvern, Victoria (AU)

(72) Inventors: Viktor Shlakhetski, Ashqelon (IL); Alexander Mostovoy, Ashqelon (IL)

(73) Assignee: INTELLITECH PTY LTD, Malvern, Victoria (AU)

(21) Appl. No.: 16/607,001

(22) PCT Filed: Jun. 21, 2018
(86) PCT No.: PCT/GB2018/051734

§ 371 Date: Oct. 21, 2019

(30) Foreign Application Priority Data
Jun. 21, 2017 (GB) 1709945.8

(51) Int. Cl. H02K 49/10

(52) U.S. Cl. CPC H02K 49/106; F16D 37/02

(57) ABSTRACT

A magnetic clutch assembly comprises circumferentially spaced coil units, a rotor, and an electrical control unit to controllably supply energizing current for inducing electromagnetic fields at each coil unit, to initiate rotation of the rotor. The rotor comprises a driving ring receivable within an interior of the coil units, a driven ring concentric to the driving ring and connectable with a mechanical load, pairs of permanent magnets consisting of a driving ring magnet and a driven ring magnet which is magnetically coupled to the driving ring magnet, and circumferentially spaced offset magnets provided with the driven ring whose magnetization direction is angularly offset to the magnetization direction of an adjacent driven ring magnet. Curving magnetic field lines of each offset magnet are superposed with the magnetic field lines of an adjacent driven ring magnet that are curving in a different direction to suppress generation of a parasitic back electromotive force.

### Field of the Invention

The present invention relates to the field of permanent-magnet based couplings. More particularly, the invention relates to an improved magnetic clutch assembly designed to control the movement of two rotating rings, without any direct or indirect mechanical connection therebetween, while reducing the level of the generated back electromotive force.

### BACKGROUND OF THE INVENTION

Some permanent-magnet based magnetic couplings for providing wear-free and contact-free transfer of forces and torques across an air gap between two rotating rings are known from the prior art. Each ring carries a set of permanent magnets so disposed that in their operative position all the north poles of one set are in operative proximity to all the south poles of the other set. A driving ring and a driven ring are thereby able to be coupled together by the force of the permanent magnets and to rotate synchronously, to produce torque from a power take-off element such as a shaft connected to the driven ring, and to thereby function as a magnetic clutch.

The inventors of the present invention have proposed to cause rotation of the driving ring of a magnetic clutch by means of induced electromagnetic fields, for example as taught by WO 2013/140400 and GB 1605744.0 by the same Applicant, which are configured to reduce the parasitic back electromotive force (EMF) that results from variations in magnetic flux that are induced when magnets of a rotor are in motion.

WO 2013/140400 discloses a brushless DC motor comprising a circular rotor configured with a plurality of circumferentially separated permanent magnets, and a plurality of circumferentially spaced and stationary stator coils that encircle the periphery of the rotor and that are structured with a void portion through which the permanent magnets can pass. Electromagnetic fields are induced when the stator coils are energized, and rotation of the rotor is initiated when an induced electromagnetic field interacts with the magnetic field of each permanent magnet. The rotor is connected to geared power transmitting means.

GB 1605744.0 discloses a similar motor having a stator which comprises a plurality of coils with a U-shaped structure in top view and double C-shaped structure in side view.

During electromagnetically-induced rotation of the rotor consisting of the magnetically coupled driving and driven rings, however, the magnetic field of each permanent magnet of the driven ring also interacts with the stator coils to produce an additional torque-reducing back EMF, while a permanent magnet of the driven ring is located externally to the corresponding stator coils at any given time. This additionally produced back EMF counteracts the reduction in back EMF realized by the apparatus of WO 2013/140400 and GB 1605744.0.

It is an object of the present invention to provide a magnetic clutch assembly whose driving ring is rotatable by means of electromagnetically-induced interaction with stator coils, but with significantly lower back EMF than prior art apparatus.

Other objects and advantages of the invention will become apparent as the description proceeds.

### SUMMARY OF THE INVENTION

The present invention provides a magnetic clutch assembly, comprising a plurality of circumferentially spaced and stationary air-core stator coil units; a rotor which comprises a driving ring suitably dimensioned such that a plurality of corresponding circumferential portions thereof are received within an interior of each of said coil units at any given time; a driven ring that is concentric to said driving ring and disposed externally to said plurality of stator coil units and that is connectable with a mechanical load; a plurality of pairs of circumferentially spaced permanent magnets, wherein each of said pairs consists of a first permanent magnet provided with said driving ring, and a second permanent magnet provided with said driven ring and of an opposite magnetization direction than said first permanent magnet, to ensure that said driving and driven rings are capable of being coupled magnetically together and of rotating synchronously; and a plurality of circumferentially spaced, offset magnet units provided with said driven ring, wherein each of said offset units comprises at least one permanent magnet whose magnetization direction is angularly offset to the magnetization direction of an adjacent driven ring magnet; and an electrical control unit configured to controllably supply energizing current for inducing electromagnetic fields at each of said stator coil units, to interact with a magnetic field of each of the permanent magnets of said driving ring to initiate rotation of said rotor while the permanent magnets of said driving ring are sequentially introduced within the interior of each of said stator coils.

Each of said offset magnets is sufficiently angularly offset to said adjacent driven ring magnet such that curving magnetic field lines of each of said offset magnets are superposed with the magnetic field lines of said adjacent driven ring magnet that are curving in a different direction to suppress generation of a parasitic back electromotive force that normally results from interaction between the magnetic field lines of said adjacent driven ring magnet and the induced electromagnetic field of a corresponding one of said air-core stator coil units.

In one aspect, each of the offset magnets is radially aligned with a corresponding one of the stator coil units. Each of the offset magnets may be radially separated by a distance of less than 5 mm from an adjacent face of the stator coil unit with which it is radially aligned, to participate in torque generation.

In one aspect, the magnetic clutch assembly further comprises a plurality of circumferentially spaced, additional offset magnets that are radially spaced from a corresponding one of the stator coil units, wherein each of said additional offset magnets is sufficiently angularly offset to a given driven ring magnet such that curving magnetic field lines of each of said additional offset magnets is superposed with the magnetic field lines of said given driven ring magnet that are curving in a different direction to suppress generation of a parasitic back electromotive force due to collective influence of both the offset magnet and the additional offset magnet

### BRIEF DESCRIPTION OF THE DRAWINGS

In the drawings:

FIG. 1 is a schematic plan view of the magnetic clutch assembly of the present invention, according to one embodiment of the present invention;

FIG. 2 is a perspective view from the top of the magnetic clutch assembly of FIG. 1, shown without the outer ring while illustrating a stationary bottom plate;

FIG. 3 is a vertical cross section of the inner ring of the magnetic clutch assembly of FIG. 1;

FIG. 4 is a perspective view from the top of the magnetic clutch assembly of FIG. 1, showing a power take-off connection;

FIG. 5 is a schematic illustration of the architecture of the electrical control unit for use in conjunction with the magnetic clutch assembly of FIG. 1, according to one embodiment of the invention, shown without the outer ring;

FIG. 6 is an enlargement of a portion of the magnetic clutch assembly of FIG. 1, shown without the inner and outer rings and illustrating the proximity between an offset magnet and a stator coil unit;

FIG. 7 is a schematic plan view of the magnetic clutch assembly of FIG. 1, shown without the air-core stator coil units and in a dynamic state; and

FIG. 8 is a schematic plan view of the magnetic clutch assembly, according to another embodiment of the invention.

### DETAILED DESCRIPTION OF PREFERRED EMBODIMENTS

As an introduction, the magnetic clutch assembly of the present invention includes a rotor that comprises two concentric rotatable rings, a first driving ring, and a second driven ring which is connected to, and provides the power for, a mechanical load. Both rings bear a plurality of circumferentially spaced permanent magnets, and corresponding magnets of the driving and driven rings are capable of being magnetically coupled together by being provided with opposite magnetization directions in order to rotate synchronously.

As referred to herein, a “magnetization direction” is the direction of a permanent magnet's axis that extends between its north and south poles while taking into account the relative N-S arrangement.

As opposed to prior art magnetic clutch assemblies by which the driving ring is connected to a mechanical device that generates motion, the rotor of the present invention is caused to rotate by interacting with a plurality of circumferentially spaced and stationary, air-core stator coils that encircle the periphery of the driving ring. Electromagnetic fields are induced when the stator coils are energized, and an induced electromagnetic field interacts with the magnetic field of each permanent magnetic of the driving ring of the present invention to initiate rotation of the rotor. The rotor continues to rotate while the permanent magnets of the driving ring are sequentially introduced within the interior of each stator coil, to produce torque without being subjected to frictional losses due to the mechanical connection to a transmission system. An exemplary motor structure employing the stator coils is described in WO 2013/140400 by the same Applicant.

As described above, the magnetic field of each permanent magnet of the driven ring also sequentially interacts with the stator coils during rotation of the rotor to produce an additional source of back EMF, in addition to the back EMF resulting from the change in magnetic flux resulting from the interaction of the rotating permanent magnets of the driving ring with the stator coils.

It has now been found, and it is the purpose of the present invention, to counteract the additional source of back EMF associated with the permanent magnets of the driven ring by providing the driven ring with an offset magnet, which is a permanent magnet that is angularly offset from the permanent magnet being magnetically coupled with the permanent magnet of the driving ring.

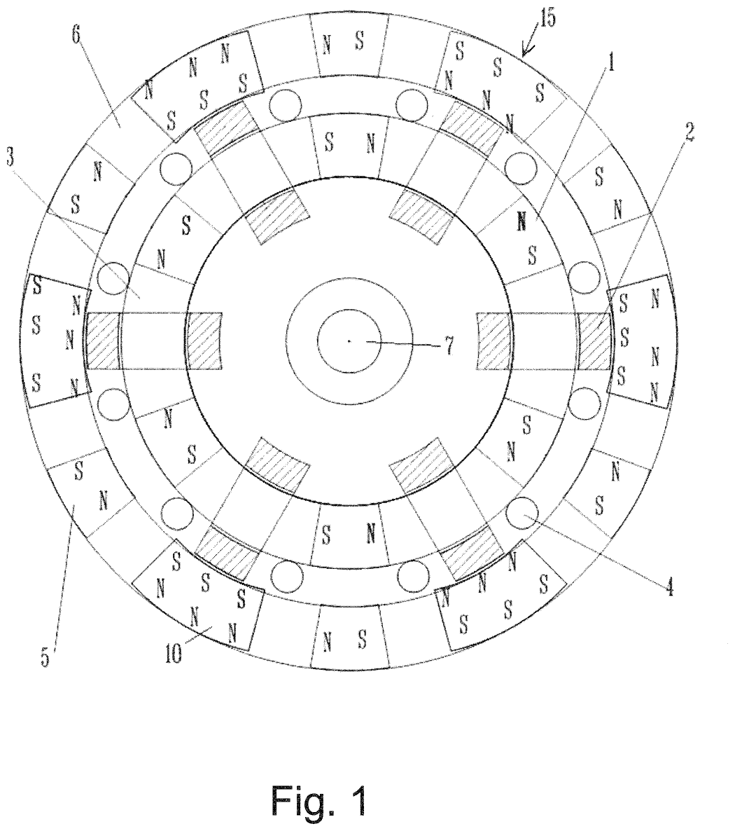

Reference is now made to FIG. 1, which schematically illustrates the magnetic clutch assembly of the present invention in plan view, generally indicated by numeral 15, according to one embodiment of the present invention.

Magnetic clutch assembly 15 comprises radially spaced inner ring 3 and outer ring 6, both of which are concentric and are coaxial with central shaft 15. Circumferentially spaced permanent magnets 1 are fixedly attached to, or otherwise provided with, inner ring 3, and circumferentially spaced permanent magnets 5 are fixedly attached to, or otherwise provided with, outer ring 6. Permanent magnets 1 and 5 are oriented such that their south-north pole is tangential to the circumference of the rings. The number of circumferentially spaced permanent magnets on each ring may vary, for example from 3-12 magnets, depending on the ring diameter.

A pair consisting of a magnet 1 of inner ring 3 and a corresponding magnet 5 of outer ring 6 is arranged with opposite magnetization directions, to ensure that the two rings will be coupled magnetically together and that they will rotate synchronously. The relative orientation of the poles is not of importance, whether the north pole is pointing in the direction of rotation or the south pole is pointing in the direction of rotation, as long as the magnetization direction of a first magnet of a pair is opposite to the magnetization direction of a second magnet of the pair.

Pairs of magnets are shown to be spaced by an equal circumferential spacing, but it will be appreciated that the invention is also applicable when they are separated by an unequal circumferential spacing.

Inner ring 3 is shown to be the driving ring as its periphery is encircled by a plurality of circumferentially spaced and stationary air-core stator coil units 2, e.g. solenoids. It will be appreciated, however, that the invention is also applicable such that outer ring 6 is the driving ring and the plurality of stator coil units 2 encircle the periphery of outer ring 6. When voltage is applied to a stator coil unit 2, an electromagnetic field is induced, and rotation of the rotor is initiated when the induced electromagnetic field interacts with the magnetic field of a nearby permanent magnet 1 of inner ring 3, causing the permanent magnet to be attracted towards the coil unit, or repelled therefrom, depending on the polarity of the applied voltage.

The plurality of circumferentially spaced and stationary air-core stator coil units 2 are arranged with radial symmetry with respect to a central shaft 7 from which power may be extracted. The axis, or long dimension, of each stator coil unit extends radially along a line between shaft 7 and outer ring 6. The air-core of each coil unit 2 has a radial dimension greater than that of inner ring 3, to permit passage of the ring therethrough when an electromagnetic field is induced. The number of stator coil units 2 is generally, but not necessarily, equal to the number of magnetically coupled permanent magnets on a given ring.

During controlled energization of the stator coil units 2, the driving inner ring 3 is urged along a circular path which is coaxial with shaft 7 by a plurality of circumferentially spaced rollers 4. For example, a friction reducing roller 4 is positioned between each stator coil unit 2 and the adjacent permanent magnet 1; however, any other arrangement of rollers, stator coils and permanent magnets is also envisioned.

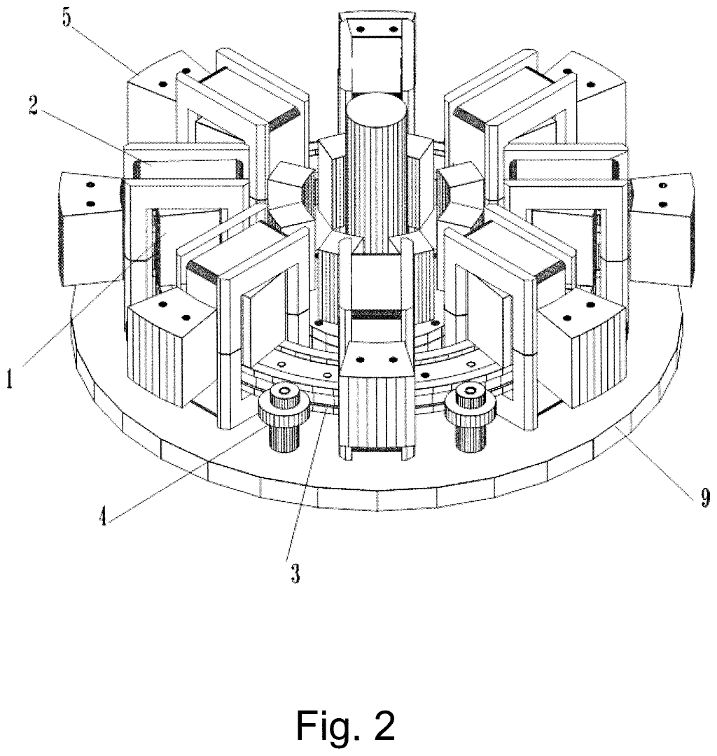

As shown in FIG. 2, each of the stator coil units 2 and rollers 4 is mounted on a stationary bottom plate 9, which may be circular as illustrated.

Permanent magnets 1 are connected to, and extend vertically from, inner ring 3, to facilitate sequential introduction into the air-core of stator coil units 2. Alternatively, permanent magnets 1 are fixed, or although provided, with inner ring 3 in other suitable ways. Although each of stator coil units 2 is shown to have a rectilinear configuration, that is with two rectangular, vertically oriented plates defining corresponding circumferential ends of the housing and a plurality of differently oriented support elements interconnecting the plates about which the coils for generating a magnetic field are wound, to accommodate the complementary rectilinear permanent magnets 1 within the similarly shaped air-core, other shapes are also within the scope of the invention. Permanent magnets 5 of the outer ring may have the same cross section as permanent magnets 1 of the inner ring, or any other desired cross section, and may also be connected to, and extend vertically from, the outer ring.

Alternatively, the permanent magnets may be formed integrally with the corresponding ring.

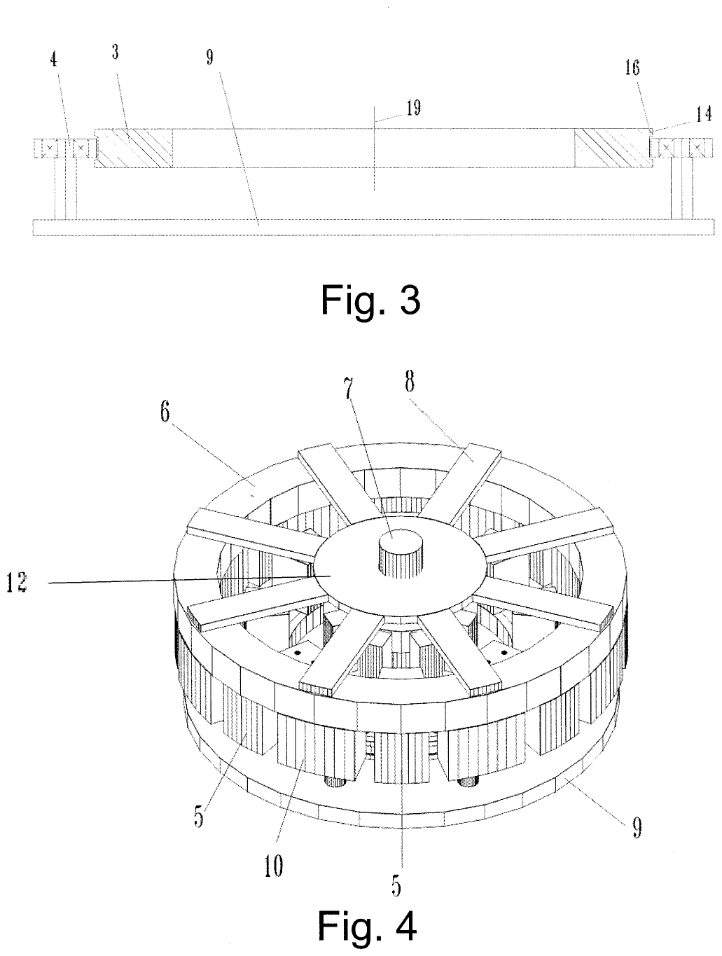

A cross section of inner ring 3 is illustrated in FIG. 3. To retain inner ring 3 at a fixed height above bottom plate 9, the outer surface 14 of inner ring 3 is formed with a continuous and radially inwardly formed recess 16, such as a notch. The radial dimension of inner ring 3 from its central axis 19 to the outer wall of recess 16 is equal to the spacing between diametrically opposite rollers 4. Thus the radial pressure applied by the rollers 4 onto inner ring 3, both when the latter is stationary or when rotating, is sufficient to support inner ring 3 above bottom plate 9. Since the outer ring is magnetically coupled with inner ring 3, the outer ring is accordingly also retained at a fixed height above bottom plate 9 even if the supply voltage is terminated.

As shown in FIG. 4, a plurality of radially extending spokes 8 connect outer ring 6 to a hub 12 encircling and connected to shaft 7, to facilitate power take-off from shaft 7. Other power transfer elements or power take-off elements may also be employed.

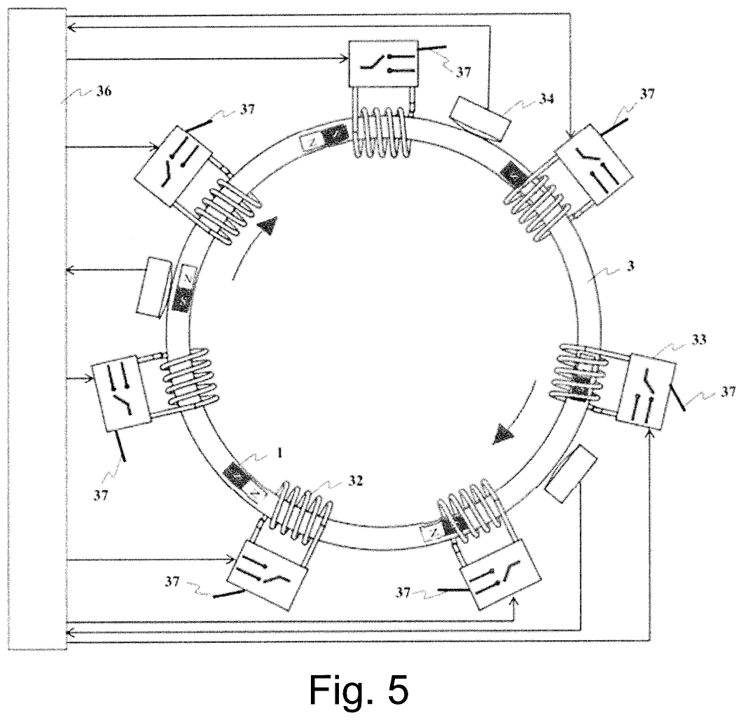

The electrical system for controllably energizing the stator coil units 22 and for thereby driving inner ring 3 is schematically illustrated in FIG. 5. Stator coil units 32, which are shown to have a tubular configuration, but which may be configured in other ways as well, are electrically connected to a DC supply through a system of switches 33, preferably, but not limitatively, of the electronic type, which determines, at each instant, the polarity and the level of the voltage applied to each stator coil unit. The switches are controlled by a component, preferably a microcontroller 36 with associated software, which determines at each instant the DC polarity applied to each coil unit 32 (e.g., by inverting the DC connection to it), as well as the average DC level (e.g., by applying the DC supply voltage using Pulse Width Modulation (PWM)). The angular position of inner ring 3 at each instant is detected by a system of sensors 34 (e.g., optical sensors or Hall-effect sensors). The sensor output is fed to the controller, which operates the switches according to the status of the rotor (i.e. angular position, speed and acceleration).

When a coil unit 32 is energized, the nearby permanent magnets 1 of the inner ring move along a circular path. The magnet is either pulled-in towards the air-core of the energized coil unit 32, or pushed-out from it, depending on the polarity of the switch associated with the given coil unit, which determines the direction of flow of the current in the windings, and on the orientation of the magnets (N-S or S-S). In turn, the status of said switch is determined at each time by the controller, based on the angular position of the rotor detected by the sensors. Under the proper simultaneous operating sequence of the overall system of switches, it is possible to obtain a continuous smooth rotation of the inner ring in either rotational direction.

Referring back to FIG. 1, parasitic back EMF is generated due to the change in magnetic flux resulting from the temporary introduction of a permanent magnet 1 within the air-core of a stator coil unit 2 during rotation. An additional source of back EMF results from the interaction of the magnetic field associated with a given permanent magnet 5 of outer ring 6 with the induced electromagnetic field associated with a stator coil unit 2 externally to which the given permanent magnet 5 is instantaneously located. Even though the given permanent magnet 5 is located externally to a stator coil unit 2, its magnetic field lines curving from the north pole to the south pole pass through the air-core and interact with the induced electromagnetic field to generate additional back EMF.

This additional back EMF can advantageously be minimized, or altogether eliminated, by providing outer ring 6 with a plurality of circumferentially spaced offset permanent magnets 10. Each offset magnet 10, which may be radially aligned with a corresponding stator coil unit 2, has one or more individual magnets, e.g. three as shown, whose magnetization direction is angularly offset to the magnetization direction of the magnets 1 and 5 that are magnetically coupled to each other. As an offset magnet 10 is relatively close to a magnetically-coupled driven ring magnet 5, the magnetic field lines of offset magnet 10 are able to be superposed with the magnetic field lines of driven ring magnet 5 to suppress the effect of the additional back EMF derived from driven ring magnet 5.

Driving ring magnets 1, driven ring magnets 5, and offset magnets 10 may be connected to the corresponding ring structure in such a way so as to protrude vertically therefrom, whether upwardly or downwardly, or, alternatively, may be coplanar with the corresponding ring structure while being positioned between two adjacent arcuate spacers. The spacers or the continuous ring structure may be made of ferromagnetic material, or high permeability material such as iron, to reduce a change in magnetic flux resulting from the interaction of the magnetic field of the rotating magnets and then of the spacers with the induced electromagnetic field of the stator coils. A dedicated robotic device may be employed to accurately position the spacers along the circumference of the rotor and to overcome the magnetic induced repulsion force.

Superior back EMF suppression can be realized when the magnetization direction of offset magnet 10 is angularly offset by an angle of 90 degrees from the magnetization direction of driven ring magnet 5 as shown. Nevertheless surprisingly effective back EMF suppression is also made possible when offset magnet 10 is angularly offset by an angle of less than 90 degrees, for example between 75-90 degrees or 45-75 degrees, or by an angle of greater than 90 degrees, for example 90-125 degrees, from the magnetization direction of driven ring magnet 5.

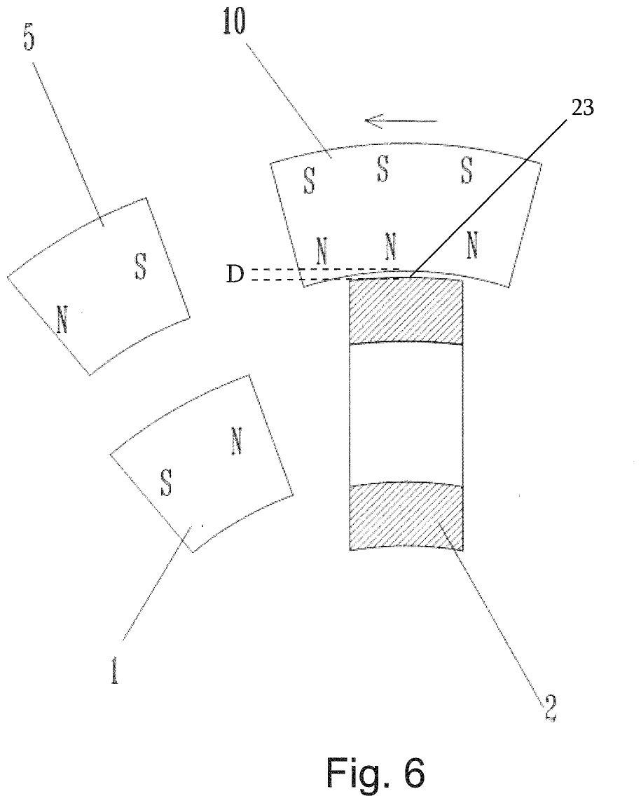

Offset permanent magnets 10 also advantageously contribute to the generation of additional torque. When each offset magnet 10 is radially separated by a distance D of less than 5 mm from the radially outward face 23 of a stator coil unit 2 with which it is instantaneously radially aligned, as shown in FIG. 6, the magnetic field of offset magnet 10 is able to interact with the portion of the electromagnetic field generated by stator coil unit 2 that extend radially outwardly from face 23. This interaction between the magnetic field of offset magnet 10 and electromagnetic field generated by stator coil unit 2 is a source of additional torque that acts on the driven ring.

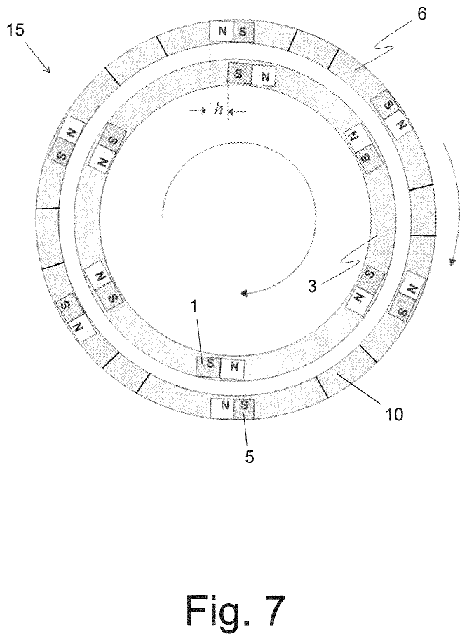

During rotation of magnetic clutch 15, as shown in FIG. 7, a permanent magnet 5 of outer ring 6 becomes circumferentially misaligned from its corresponding permanent magnet 1 of inner ring 3 with which it is magnetically coupled, due to the influence of the load to which outer ring 6 is connected. This dynamic state is in contrast to a static state when magnetic clutch 15 is at rest and permanent magnet 5 is circumferentially aligned with the corresponding permanent magnet 1 with which it is magnetically coupled.

During the misalignment, the relative position of magnets 1 and 5 will shift in a quasi-linear fashion tangentially to the circumference of rings 5 and 6. Eventually, magnets 1 and 5 will reach a circumferential offset h, as shown, which will stabilize and not substantially change. The offset h will depend on the opposing force exercised by the load. Under proper conditions, h will increase directly proportionally to the force needed to make the outer driven ring 6 rotate along with the inner driving ring 3.

It will be presented that in the range of interest, the offset h is roughly directly proportional to the force transfer, and as long as h is not too large, driving ring 3 will be able to propel the driven ring 6, without the occurrence of any physical contact between rings 3 and 6. When the magnitude of h approaches the width of the gap between the magnets 1 and 5, the force transferred drops. The maximal force that driving ring 3 will be able to apply to driven ring 6 will depend on the strength and on the geometry of the permanent magnets, on the number of magnets, as well as on the gap between the two rings 3 and 6.

### EXAMPLE 1

### Back EMF Suppression

The effect of back EMF suppression provided by an offset magnet was studied in test apparatus comprising a magnetic clutch assembly according to the teachings of the present invention, which had a rotor comprising two concentric and radially spaced magnetically coupled rings configured such that the diameter of the outer ring was 400 mm. One air-core stator coil unit was employed that encircled the periphery of the inner ring.

A coil having an electrical resistance of 6 μΩ was evenly wound by 20 turns about the support elements interconnecting two vertically oriented plates which were spaced by 50 mm and positioned at corresponding circumferential ends of the rectilinear stator coil housing, to define an inductance of 40 μH. The air-core was dimensioned with a size of 50×70×80 mm.

Six evenly spaced permanent magnets dimensioned each with a size of 50×50×80 mm were attached to each ring, while a magnet attached to the inner ring was radially aligned with, and magnetically coupled to, a corresponding magnet attached to the outer ring. A magnet attached to the outer ring was radially spaced from a corresponding magnet attached to the inner ring by a distance of 22 mm.

Voltage was supplied to the coil at different discrete levels via switch-connected conductor 37 (FIG. 5) to cause the rotor to rotate at a corresponding speed, the value of which was measured by a photoelectric sensor and an oscilloscope and listed in Table I. The back EMF (BEMF) that was generated for each corresponding speed was measured, and also listed in Table I.

TABLE I
BEMF without Offset Magnets

| RPM | BEMF (V) |
|---|---|
| 500 | 0.23 |
| 1000 | 0.85 |
| 1500 | 1.55 |

Six additional permanent magnets each dimensioned with a size of 50×50×20 mm were then attached to the outer ring so as to be circumferentially separated by 30 degrees from a corresponding magnetically coupled magnet, and were angularly offset to the magnetization direction of the magnets attached to the outer ring by 90 degrees.

Voltage was supplied to the coil at different discrete levels to cause the rotor provided with the additional offset magnets to rotate at the same speeds listed in Table I. The back EMF (BEMF) that was generated for each corresponding speed was measured and listed in Table II. As demonstrated, the BEMF was reduced by a value ranging from 22-26%.

TABLE II
BEMF with Offset Magnets

| RPM | BEMF (V) |
|---|---|
| 500 | 0.18 |
| 1000 | 0.63 |
| 1500 | 1.15 |

### EXAMPLE 2

### Additional Torque Generation

The effect of additional torque generation provided by an offset magnet to the rotor was studied in the same test apparatus described in Example 1.

Current was supplied to the coil via switch-connected conductor 37 (FIG. 5) at different discrete levels to cause the rotor to rotate at a corresponding speed. The torque generated by the rotor provided without the offset magnets was measured by Torque Sensor Model 8645 manufactured by Burster Praezisionsmesstechnik Gmbh & Co., Gernsbach, Germany and listed in Table III for each current level.

The six offset magnets were then connected to the outer ring such that they were radially separated by a distance ranging from 2-5 mm from the radially outward face of the single stator coil unit when radially aligned therewith, after which the same discrete levels of current were supplied to the coil and the corresponding level of torque that was generated was measured and listed in Table IV. As demonstrated, the torque that was generated as a result of the use of the offset magnets was increased by a value ranging from 9.3-11.5%.

TABLE III
Generated Torque without Offset Magnets

| Current (A) | Torque (Nm) |
|---|---|
| 100 | 21.0 |
| 200 | 41.8 |
| 400 | 86.0 |

TABLE IV
Generated Torque with Offset Magnets

| Current (A) | Torque (Nm) |
|---|---|
| 100 | 23.0 |
| 200 | 46.6 |
| 400 | 94.0 |

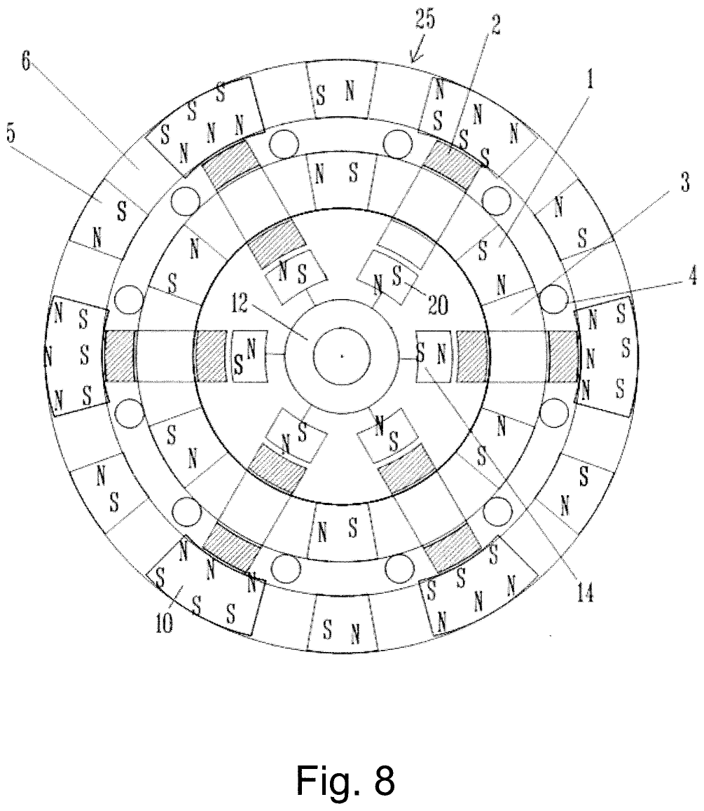

FIG. 8 illustrates a magnetic clutch assembly 25 according to another embodiment of the invention. Magnetic clutch assembly 25 is identical to magnetic clutch assembly 15 of FIG. 1, but with the addition of another set of offset magnets 20. A plurality of additional offset magnets 20 are connected to hub 12 encircling and connected to the central shaft in such a way that an offset magnet 20 is aligned with, and slightly spaced from, a corresponding stator coil unit 2. Thus back EMF suppression, for a single driven ring magnet 5, is made possible by the collective influence of both offset magnet 10 and offset magnet 20.

Additional offset magnets 20 may also be configured to be radially separated by a distance of less than 5 mm from the radially inward face of a stator coil unit 2 with which it is instantaneously radially aligned. The magnetic field of each additional offset magnet 20 is able to interact with the portion of the electromagnetic field generated by a stator coil unit 2 that extends externally and radially inwardly from the stator coil unit. This interaction between the magnetic field of an additional offset magnet 20 and the electromagnetic field generated by a stator coil unit 2 is a source of additional torque that acts on the driven ring.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A magnetic clutch assembly, comprising:
a) a plurality of circumferentially spaced and stationary air-core stator coil units;
b) a rotor which comprises:
i. a driving ring suitably dimensioned such that a plurality of corresponding circumferential portions thereof are received within an interior of each of said coil units at any given time;
ii. a driven ring that is concentric to said driving ring and disposed externally to said plurality of stator coil units and that is connectable with a mechanical load;
iii. a plurality of pairs of circumferentially spaced permanent magnets, wherein each of said pairs consists of a first permanent magnet provided with said driving ring, and a second permanent magnet provided with said driven ring and of an opposite magnetization direction than said first permanent magnet, to ensure that said driving and driven rings are capable of being coupled magnetically together and of rotating synchronously; and
iv. a plurality of circumferentially spaced, offset magnet units provided with said driven ring, wherein each of said offset units comprises at least one permanent magnet whose magnetization direction is angularly offset to the magnetization direction of an adjacent driven ring magnet; and
c) an electrical control unit configured to controllably supply energizing current for inducing electromagnetic fields at each of said stator coil units, to interact with a magnetic field of each of the permanent magnets of said driving ring to initiate rotation of said rotor while the permanent magnets of said driving ring are sequentially introduced within the interior of each of said stator coils,
wherein each of said offset magnets is sufficiently angularly offset to said adjacent driven ring magnet such that curving magnetic field lines of each of said offset magnets are superposed with the magnetic field lines of said adjacent driven ring magnet that are curving in a different direction to suppress generation of a parasitic back electromotive force that normally results from interaction between the magnetic field lines of said adjacent driven ring magnet and the induced electromagnetic field of a corresponding one of said air-core stator coil units.

2. The magnetic clutch assembly according to claim 1, wherein each of the offset magnets is angularly offset to the adjacent driven ring magnet by an angle ranging from 45 to 125 degrees.

3. The magnetic clutch assembly according to claim 2, wherein each of the offset magnets is angularly offset to the adjacent driven ring magnet by an angle substantially equal to 90 degrees.

4. The magnetic clutch assembly according to claim 1, wherein each of the offset magnets is radially aligned with a corresponding one of the stator coil units.

5. The magnetic clutch assembly according to claim 4, wherein each of the offset magnets is radially separated by a distance of less than 5 mm from an adjacent face of the stator coil unit with which it is radially aligned, to participate in torque generation.

6. The magnetic clutch assembly according to claim 1, wherein each of the stator coil units is arranged with radial symmetry with respect to a central shaft from which power is extractable.

7. The magnetic clutch assembly according to claim 6, further comprising a plurality of circumferentially spaced, additional offset magnets that are radially spaced from a corresponding one of the stator coil units, wherein each of said additional offset magnets is sufficiently angularly offset to a given driven ring magnet such that curving magnetic field lines of each of said additional offset magnets is superposed with the magnetic field lines of said given driven ring magnet that are curving in a different direction to suppress generation of a parasitic back electromotive force due to collective influence of both the offset magnet and the additional offset magnet.

8. The magnetic clutch assembly according to claim 7, wherein the plurality of additional offset magnets are connected to a hub encircling and connected to the central shaft.

9. The magnetic clutch assembly according to claim 6, wherein the driving and driven rings are coaxial with the central shaft.

10. The magnetic clutch assembly according to claim 6, further comprising a power take-off connection interconnecting the driven ring and the central shaft.

11. The magnetic clutch assembly according to claim 10, wherein the power take-off connection is configured with a plurality of circumferentially spaced linear elements that radially extend from the driven ring to the central shaft.
